(19) United States
(12) Patent Application Publication
(10) Pub. No.: US 2026/0178061 A1
(43) Pub. Date: Jun. 25, 2026

(54) OPTIMIZED CONTROL OF FLOW ENTITIES OF HYDROCARBON RESERVOIR

(71) Applicant: TotalEnergies OneTech, Courbevoie (FR)

(72) Inventor: Pierre Bergey, Pau (FR)

(21) Appl. No.: 19/407,423

(22) Filed: Dec. 3, 2025

(30) Foreign Application Priority Data
Dec. 19, 2024 (EP) 24307198.2

(51) Int. Cl. G05D 7/06; E21B 43/12; G05B 13/04

(52) U.S. Cl. CPC G05D 7/0623; E21B 43/12; G05B 13/04; E21B 2200/20

(57) ABSTRACT

A computer-implemented method for determining an optimized control of flow entities of a hydrocarbon reservoir includes obtaining a meshed representation of flow entities, wherein each flow entity is described by a flow entity node and each link between the flow entities is described a flow entity edge; the flow entity nodes being ordered using ranks according to a flow entity property and the flow entity edges being ordered using ranks according to a flow entity relationship property; determining at any simulated time an order of the flow entity nodes using ranks according to a combined node-edge property derived from a flow entity property and a flow entity relationship property; applying at a variation parameter to the properties; and determining the optimized control of the flow entities from at least an order of the flow entities determined using an optimization of a cost function, the variation parameter being an optimization variable.

### BACKGROUND

### Technical Field

This disclosure pertains to the field of simulation reservoir. More particularly, the present disclosure relates to a method and a computing device for determining an optimized control of flow entities of a hydrocarbon reservoir.

### Description of the Related Art

There are existing methods to optimize the management or control of flow entities such as completions, wells, or groups of wells, taking into account the constraints associated with these objects. These constraints can relate to a wide range of operating conditions, such as flow rates, pressure, temperature, and compositions, and can be specific to a fluid phase and be time-dependent.

For example, these methods may allow to determine an order or priorities across flow entities. For instance, an order of wells can correspond to the order of well openings, the order of well drilling, the order for adding flow assistance equipment (pumps, gas lift mandrels) to flow entities, etc.

Well priorities can control the way flow for a considered flow quantity, constrained for a group of flow entities, is distributed across the entities constituting such group. Such repartition can relate to many different flow quantities pertaining to the flow direction (production or injection), the nature the constraint (water, oil, gas, compositional component flow, pressure or pressure differential, etc.), the role that the fluid flow play in the industrial process (fluid that is a product, a waste, an ancillary flow, etc.).

Group level constraints may include a rate constraint pertaining to a given fluid stream (e.g., oil rate below value X), a pressure or temperature constraint pertaining to a given point in a flow system (bottom hole pressure higher or equal to value Y), etc.

Pre-existing methods for determining an order may rely upon sorting flow entities based upon a property solely dependent of the properties of the considered flow entity. The dependency might involve a mathematical combination of time dependent properties of the considered flow entity.

Pre-existing method for determining priorities may include at least the following:
a) Direct input of numerical priority property values per entity. The priority of a flow entity is computed by normalization of the entity priority value normalized by the sum of priority properties values for the considered flow entities.
b) Computation of priority properties by mathematical combination of entity properties in which the priority property of an entity is dependent solely of properties of the entity considered. Resulting priorities are normalized as per approach a).
c) Computation of priority properties along a Waterflood optimization aiming at equalizing water sweep over the reservoir acreage approach as detailed in the document “Using Streamline-Derived Injection Efficiencies for Improved Waterflood Management”, paper SPE 84080, Society of Petroleum Engineers Journal (2006), 9, No. 2.”
d) Computation of priority properties using a Proportional Integral Derivative approach to aim at equalizing pressure in various parts of the reservoir as per the following documents:
Güyagüler, B. and Byer, T., “A New Rate-Allocation-Optimization Framework,” paper SPE 105200, SPE Production & Operations (2008), 23, No. 4, 448-457; also presented at the SPE Reservoir Simulation Symposium, Houston, Texas, USA (Feb. 16-28, 2007).
Güyagüler, B., Zapata, V. J., Cao, H., Stamati, H. F. and Holmes, J. A.: “Near-Well Subdomain Simulations for Accurate Inflow Performance Relationship Calculation to Improve Stability of Reservoir-Network Coupling,” paper SPE 141207, SPE Reservoir Evaluation & Engineering (2011), 14, No. 5, 634-643; also presented at SPE Reservoir Simulation Symposium, The Woodlands, Texas, USA (Feb. 21-23, 2011).

However, these methods are complex to implement, are hardware and time-consuming, and may miss one or more optimal configurations or, most importantly delay the identification of comparatively performing or optimal control when included in automated optimization processes. Most advanced ones, such as Waterflood optimization and/or Proportional Integral Derivative, aim at (and quite successfully enable) implementing heuristics which are not always optimal from an economic viewpoint. Thus, there is no guarantee that the proposed solution is optimal.

The present method improves the situation, by widening the range of heuristics that can be used to construct a tentatively optimal ordering of and/or attribution of priorities to flow entities and enabling balancing between such heuristics.

### BRIEF SUMMARY

Proposed herein is a computer-implemented method for determining an optimized control of flow entities of a hydrocarbon reservoir. In various embodiments, the method may comprise:
a/ obtaining a meshed representation of flow entities, the representation comprising nodes and edges connecting the nodes, each flow entity being described by a node called flow entity node and each link between the flow entities being described by an edge called flow entity edge, the flow entity nodes being described by at least one property called flow entity property and the flow entity edges being described by at least one property called flow entity relationship property,
the flow entity nodes being ordered according to the at least one flow entity property such that each flow entity node has a respective rank according to the at least one flow entity property,
and the flow entity edges being ordered according to the at least one flow entity relationship property such that each flow entity edge has a respective rank according to the at least one flow entity relationship property;
b/ determining at any simulated time an order of the flow entity nodes according to at least one property called combined node-edge property, the combined node-edge property being derived from a flow entity property among the at least one flow entity property and a flow entity relationship property among the at least one flow entity relationship property, each rank of a flow entity node according to the at least one combined node-edge property being determined from:
   the respective ranks according to a flow entity property among the at least one flow entity property of the flow entity nodes directly connected to the flow entity node; and
   the respective ranks according to a flow entity relationship property among the at least one flow entity relationship property of the flow entity edges directly connected to the flow entity node;
c/ applying at least one variation parameter to at least one among the at least one flow entity property and the at least one combined node-edge property; and
d/ determining the optimized control of the flow entities from at least an order of the flow entities determined using an optimization of a cost function, the at least one variation parameter being an optimization variable, the optimization comprising iterations of:
d1/ determining a plurality of global ranks for the flow entity nodes, each global rank of a flow entity node being determined from the respective rank of the flow entity node for the at least one flow entity property and from the respective rank of the flow entity node for the at least one combined node-edge property;
d2/ determining an order of the flow entities based on the global ranks; and
d3/ evaluating the cost function based on the determined order of the flow entities.

Thus, advantageously, an optimized control of the flow entities may be simply determined by transforming the input data into ranks, corresponding to an order of the flow entities. In the context of the present disclosure, the optimized control of the flow entities may also correspond (or based on) to at least a determined order of the flow entities (minimizing a cost function), which is determined by varying at least one variation parameter such the directional parameter and/or the weight. According to an example, depending on the type of flow entity(ies), the order may be the order of well openings, the order of well drilling, the order for adding flow assistance equipment (pumps, gas lift mandrels) to flow entities, etc. A benefit of the approach relates to the reduced number of parameters involved in the determination of ranks compared to alternate method(s) while maintaining an ability to investigate a wide and diverse range of rank combination. Another benefit lies in the ability to establish a relation between performing designs and input properties (explainability).

In one or several embodiments, the rank and the at least one variation parameter may be comprised between 0 and 1. Depending on the chosen convention, the highest rank may correspond to the highest value of the rank, such 1, and the lowest rank may correspond to the smallest value of the rank, such 0. Inversely, the highest rank may correspond to the smallest value of the rank, such 0, and the lowest rank may correspond to the highest value of the rank, such 1. Such interpretations may be considered for all the present disclosure.

By the flow entity nodes directly connected to the flow entity node, it may be understood that the flow entity nodes are directly connected by a respective edge (or at least one respective edge) to the flow entity node.

A “flow entity” may refer to an equipment within a reservoir that facilitates the movement, extraction, injection, or management of fluids such as oil, gas, water, or other substances.

A “hydrocarbon reservoir” (or a geological reservoir) refers to a subsurface formation or a series of formations that contain accumulations of fluids such as oil, gas, water, hydrogen, or other substances, or may also be operated to store resources such as carbon dioxide or hydrogen.

In one or more embodiments, one or more ranks of the properties may be derived from a geological description of the subsoil comprising the hydrocarbon reservoir. Such geological description may be obtained from the memory of the computing device and/or received by the communication interface of the computing device and storing in its memory. The geological description of the subsoil may be used to build the meshed representation. The geological description may provide data about the subsurface formation, which may include at least dimensional data (dimensions of the reservoir, location, volume, etc.) as well as geological data, including rock types, petrophysical parameters such as porosity, permeability, saturation, etc. The geological description may include, or be derived from, various types of ground data acquired on the reservoir, such as:
seismic data (such at least one seismic image),
well log data, and
core and plug data.

In one or several embodiments, the at least one variation parameter of a property may be chosen among at least:
a directional parameter determining an impact of the evolution of a property according to a given direction on a rank; and
a weight.

The directional parameter may be a coefficient of direction which may indicate whether or not a given property should be maximized or minimized in the subsequent steps of the method. The directional parameter may transcribe the relevance of a rank (or the relevance of its respective value) of a flow entity node regarding the property. For instance, it may consider that a respective value or rank for a given property may be optimal or not when it is high or low, maximum or minimum, or in the average, etc.

The weight may correspond to the importance given to a property, such as the flow entity property or the combined node edge property. The weight may be set automatically, for instance based on a database (or predetermined database or based on experimental measurements), or defined by a user such reservoir engineers and/or reservoir geologists.

In one or several embodiments, the flow entity nodes may be described by a plurality of flow entity properties and/or the flow entity edges may be described by a plurality of flow entity relationship properties, and in b/ the ranks may be determined according to a plurality of combined node-edge properties for the flow entity nodes such that each flow entity node may have a respective rank for each combined node-edge property of the plurality of combined node-edge properties.

In one or several embodiments, determining the plurality of global ranks may comprise:
for each flow entity node, calculating a respective distance for the flow entity node from the respective rank of the flow entity node for the at least one flow entity property and from the respective rank of the flow entity node for the at least one combined node-edge property; and
determining a global rank for each flow entity node from a comparison between the respective distance calculated for the flow entity node with the distances calculated for the other flow entity nodes.

In one or several embodiments, the variation parameter may be a weight such that the properties are weighted among each other by a plurality of weights, and wherein the respective distance of each flow entity node is further calculated from the plurality of weights.

In one or several embodiments, each flow entity node may be described by a respective value of the at least one flow entity property, and each flow entity edge may be described by a respective value of the at least one flow entity relationship property, and the method may comprise in a/:
for each flow entity node, determining the respective rank for the at least one flow entity property from a comparison between the respective value of the flow entity node for the at least one flow entity property with the respective values of the other flow entity nodes for the at least one flow entity property; and
for each flow entity edge, determining the respective rank for the at least one flow entity relationship property from a comparison between the respective value of the flow entity edge for the at least one flow entity relationship property with the respective values of the other flow entity edges for the at least one flow entity relationship property.

In one or several embodiments, one or more respective values of the properties may be derived from a geological description of the subsoil comprising the hydrocarbon reservoir, as presented previously. In one or more embodiments, one or more respective values may be obtained by experimental measurements performed in the subsoil comprising the hydrocarbon reservoir, such using seismic image(s) or by using conventional techniques suitable for measuring such respective value(s).

In one or several embodiments, in b/, the respective ranks for the flow entity nodes according to the at least one combined node-edge property may be determined as follows:
for each flow entity node N for the at least one combined node-edge property, determining a sum S for the flow entity node according to:

$${S}_{N}^{( P N ; P L )} = ( {\sum }_{all DistantNodes nodes}^{all Node to - DistantNode edges} {Rank}_{DistantNodes}^{DistantNode} ( P N ) . {Rank}_{to - DistantNode edges}^{to - DistantNode edge} ( P L ) )$$

wherein

$${Rank}_{DistantNodes}^{DistantNode}$$

is a rank according to a flow entity property PN among the at least one flow entity property of a DistantNode, the DistantNode being directly connected to the flow entity node, and

$${Rank}_{to - DistantNode edges}^{to - DistantNode edge}$$

is a rank according to an flow entity relationship property PL among the at least one flow entity relationship property of a flow entity edge, the flow entity edge being directly connected to the flow entity node; and
determining a respective rank for each flow entity node for the at least one combined node-edge property from a comparison between the respective sum calculated for the flow entity node with the sums calculated for the other flow entity nodes.

In one or several embodiments, the at least one flow entity property may be chosen among:
a Cumulated oil production;
a Gas in place around flow entity;
a Lorenz heterogeneity coefficient computed along a drain interval;
a Gas oil ratio;
a Bottom Hole Flowing Pressure; and
a Priority computed from any pre-existing method.

In one or several embodiments, the at least one flow entity relationship property may be chosen among:
a Euclidian distance;
a Time of flight;
an Allocation factor in the meaning of Waterflood optimization;
a Time to breakthrough or Time to given water cut level;
an Interference profile; and
a Capacity or a Resistance resulting from a CRM modelling approach.

In one or several embodiments, the optimization may take into account at least one order constraint chosen among:
imposing an ordering constraint between specific flow entities; and
imposing an ordering constraint between specific groups of flow entities.

In one or several embodiments, the optimized control of the flow entities may further be determined from at least a list of flow entity priorities determined by using the optimization of the cost function, the flow entity priorities being obtained by transforming a determined order of the flow entities factoring at least one application constraint at entity level for each entity.

Thus, advantageously, an optimized control of the flow entities (or of the repartition of flow entities) based on a list of flow entity priorities may be simply determined by transforming a determined order of flow entities in a series of flow priorities. In the context of the present disclosure, the optimized control of the flow entities may also correspond (or based on) to at least a list of flow entity priorities, also called allocation factors, which is determined by varying at least one variation parameter such the directional parameter and/or the weight and/or alpha and/or beta. According to an example, depending on the type of flow entity, well priorities can control the way flow for a considered flow quantity, constrained for a group of flow entities, is distributed across the entities constituting such group. Another benefit is that the flow priorities depend solely on the order of flow entities making the problem more suited to optimization process and more explainable.

In one or several embodiments, the determined order of the flow entities may be transformed into the list of flow entity priorities based on a beta law cumulative distribution function and based on the at least one application constraint at flow entity level of each flow entity, the beta law cumulative distribution function being dependent on parameters alpha and beta as variation parameters.

In one or several embodiments, the optimization may take into account at least one priority constraint chosen among:
a priority value of a flow entity must be lower or higher than a predetermined value; and
a priority value of a first flow entity must be lower or higher than a priority value of a second flow entity.

In one or several embodiments, at least one application constraint may be chosen among:
a rate constraint pertaining to a given fluid stream; and
a pressure or temperature constraint pertaining to a given point in a flow system.

In one or several embodiments, the optimized control of the flow entities is determined from an order of the flow entities and a list of flow entity priorities which are determined using the optimization of the cost function with at least a first variation parameter and at least a second variation parameter as optimization variables, the at least first variation parameter is chosen among a directional parameter and a weight, and the at least second variation parameter is chosen among an alpha parameter and a beta parameter.

In one or several embodiments, the list of flow entity priorities may be determined by transformation as follows:
computing unconstrained cumulated priorities using the beta law cumulative distribution function and the global ranks of the determined order of the flow entities;
computing unconstrained individual priorities for each flow entity by differentiating two successive unconstrained cumulated priorities;
computing a flow target for each flow entity and each application constraint of the at least one application constraint by multiplying the application constraint at the group level by the unconstrained individual priorities computed;
computing a maximum individual constrained priority per flow entity as a proportion between the flow target of the flow entity and the flow target of the application constraint whenever the application constraint is exceeded; and
determining the list of flow entity priorities by summing the individual constrained priorities and redistributing recursively the difference between individual constrained priorities and unconstrained individual priorities over individual unconstrained flow entities according to their individual unconstrained priorities until all flow entities are constrained or a redistribution is achieved without an entity reaching a constraint.

By unconstrainted/constrained, it may be understood unconstrained/constrained regarding the application constraint.

In one or several embodiments, the at least one variation parameter may be applied to the ranks of the properties.

In one or several embodiments, a normalization of the ranks according to a property may be performed taking into account the at least one variation parameter.

In one or several embodiments, the optimization of the cost function may be a maximization or a minimization of the cost function.

In one or several embodiments, the cost function may be chosen among a Cumulated production or injection, a Discounted Net present Value, or a Return on Investment.

In one or several embodiments, a flow entity may be at least one flow entity chosen among:
a producer well or a group of producer wells;
an injector well or a group of injector wells;
a drain production interval, or a group of drain production intervals; and
a drain injection interval or a group of drain injection intervals.

In another aspect of the present disclosure, a computer program product is proposed comprising instructions which, when the program is executed by a computer, cause the computer to carry out the method of the present disclosure.

In another aspect of the present disclosure, a computer-readable non-transient recording medium is proposed on which a software is registered to implement the present disclosure as defined here when the software is executed by a processor.

In another aspect of the present disclosure, a computing device is proposed for determining an optimized control of flow entities of a hydrocarbon reservoir, the computing device comprising a memory and comprising:
a/ a circuit for obtaining and for storing in the memory a meshed representation of flow entities, the representation comprising nodes and edges connecting the nodes, each flow entity being described by a node called flow entity node and each link between the flow entities being described by an edge called flow entity edge, the flow entity nodes being described by at least one property called flow entity property and the flow entity edges being described by at least one property called flow entity relationship property,
the flow entity nodes being ordered according to the at least one flow entity property such that each flow entity node has a respective rank according to the at least one flow entity property,
and the flow entity edges being ordered according to the at least one flow entity relationship property such that each flow entity edge has a respective rank according to the at least one flow entity relationship property;
b/ a circuit for determining at any simulated time an order of the flow entity nodes according to at least one property called combined node-edge property, the combined node-edge property being derived from a flow entity property among the at least one flow entity property and a flow entity relationship property among the at least one flow entity relationship property, each rank of a flow entity node according to the at least one combined node-edge property being determined from:
   the respective ranks according to a flow entity property among the at least one flow entity property of the flow entity nodes directly connected to the flow entity node; and
   the respective ranks according to a flow entity relationship property among the at least one flow entity relationship property of the flow entity edges directly connected to the flow entity node;
c/ a circuit for applying at least one variation parameter to at least one among the at least one flow entity property and the at least one combined node-edge property; and
d/ a circuit for determining the optimized control of the flow entities from at least an order of the flow entities determined by using an optimization of a cost function, the at least one variation parameter being an optimization variable, the optimization comprising iterations of:
   d1/ determining a plurality of global ranks for the flow entity nodes, each global rank of a flow entity node being determined from the respective rank of the flow entity node for the at least one flow entity property and from the respective rank of the flow entity node for the at least one combined node-edge property;
   d2/ determining an order of the flow entities based on the global ranks; and
   d3/ evaluating the cost function based on the determined order of the flow entities.

### BRIEF DESCRIPTION OF THE SEVERAL VIEWS OF THE DRAWINGS

Other features, details and advantages will be shown in the following detailed description and on the figures, on which:

FIG. 1 illustrates a schematic view of an exploitation of a hydrocarbon reservoir in an area.

FIG. 2 illustrates a flowchart of the method according to the present disclosure.

FIG. 3 illustrates an example of mesh representation of flow entities.

FIG. 4 provides examples of orders of ranks according to the present disclosure.

FIG. 5 provides examples of respective values according to the present disclosure.

FIG. 6 illustrates an example of effect on the ranks when applying a directional parameter through a trigonometric function.

FIG. 7 illustrates an example of a hypercube in two dimensions.

FIG. 8 illustrates a computing device configured to implement the method according to the present disclosure.

### DETAILED DESCRIPTION

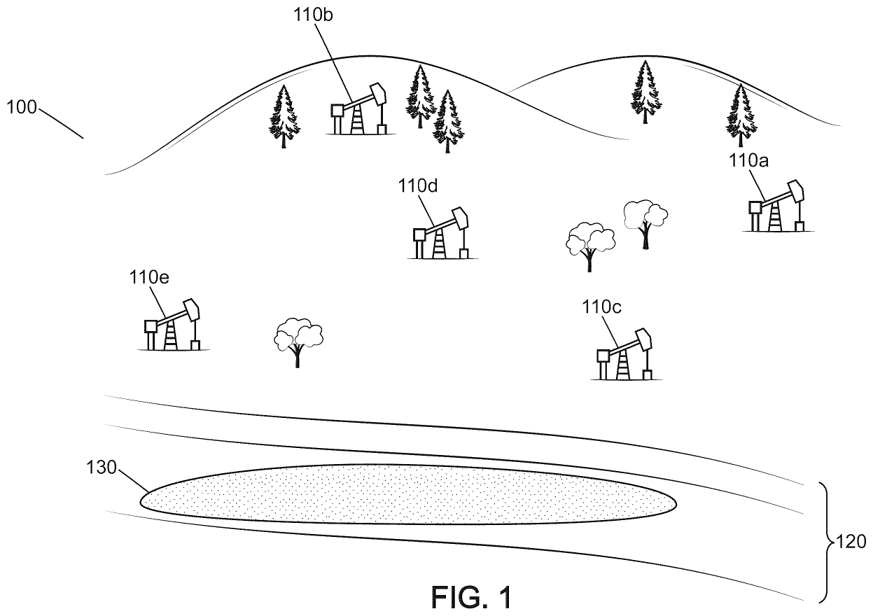

FIG. 1 illustrates a schematic view of an exploitation of a hydrocarbon reservoir in an area 100.

The area (or zone) 100 may be an area comprising a subsoil 120 having stratigraphic layers which may form a hydrocarbon reservoir 130 (or geological reservoir), such gas or oil for instance, and in which an exploitation is installed or will be installed or will be modified.

This hydrocarbon exploitation may have one or more flow entities 110a, 110b, 110c, 110d, 110e (or set of flow entities) to exploit the hydrocarbon reservoir 130 or in the view to exploit the hydrocarbon reservoir 130.

A “flow entity” may refer to an equipment within a reservoir that facilitates the movement, extraction, injection, or management of fluids such as oil, gas, water, or other substances.

In one or more embodiments, the flow entity may be at least one flow entity chosen among:
a producer well or a group of producer wells;
an injector well or a group of injector wells;
a drain production interval or a group of drain production intervals; and
a drain injection interval or a group of drain injection intervals.

A “hydrocarbon reservoir” (or a geological reservoir) may refer to a subsurface formation or a series of formations that contain accumulations of fluids such as oil, gas, water, hydrogen, or other substances, or may also be operated to store resources such as carbon dioxide or hydrogen, for instance in the context of CCUS (Carbon Capture, Utilization and Storage) and/or Geothermal (with previous presented flow entities or other types of flow entity). In the context of the present disclosure, the hydrocarbon reservoir may correspond to a real, existing reservoir for which ground data describing at least some geological and/or geometrical properties is available or can be acquired. The ground data can notably include, or be derived from, campaigns of seismic reflections, in-situ observations of geologists, satellite or aerial images, or wellbore data, including well logs, cores and plugs.

In the context of FIG. 1, the flow entities (or set of flow entities) may be wells (or a group of wells). However, alternatively, the flow entities 110a, 110b, 110c, 110d, 110e may also be a set comprising one or more wells or groups of wells, and/or one or more injection wells or groups of injection wells, and/or one or more drain production intervals, etc.

In addition, in the context of the present disclosure, the flow entities can be a group of groups of flow entities.

By “producer well”, it may be understood a well for which a desired fluid, such oil or gas for instance, is produced. Hence, producer wells aim at the extraction of the desired fluid which may be carried out by a drain production interval of the well producer.

By “injector well”, it may be understood a well for which a fluid, such water for instance, is injected rather than produced. Injector wells, performed at a drain injection interval of the well, aim at maintaining reservoir pressure and substituting one fluid by another in the reservoir thus enhancing the production of the desired fluid at the producer wells.

Thus, it may be understood that the flow entities may be connected between them, but not necessary, and which may be interpreted by one or more links. For instance, a link between two flow entities may be for instance defined, among others, by a time of flight between these two flow entities. A flow entity may be connected to one or more flows entities.

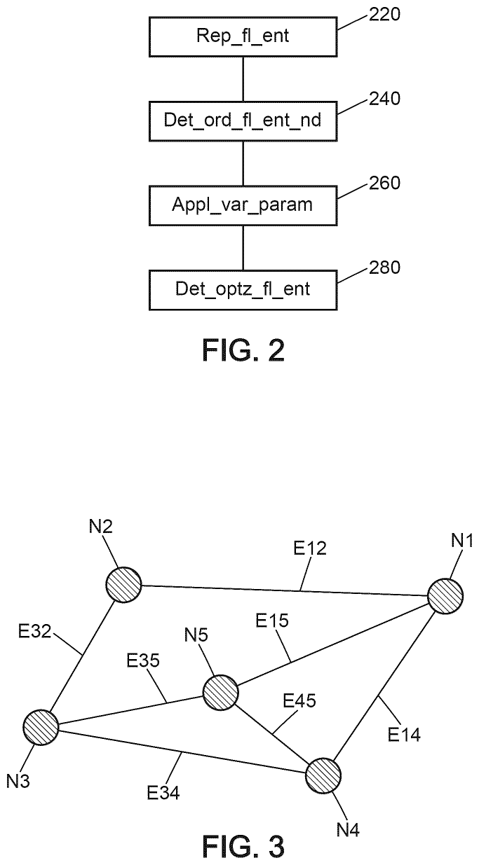

FIG. 2 illustrates a flowchart of the method according to the present disclosure.

The method may be implemented by a computing device, such a computer or a computing server, comprising a memory and processor.

The method may consist of obtaining 220 a meshed representation of the flow entities (or a set of flow entities) as illustrated at FIG. 3.

The meshed representation may be for instance received by the communication interface of the computing device and/or obtained from the memory of the computing device.

According to one or more embodiments, the meshed representation may be built on a geological description of the subsoil comprising the hydrocarbon reservoir. Such geological description may be obtained from the memory of the computing device and/or received by the communication interface of the computing device and storing in its memory. The geological description may provide data about the subsurface formation, which may include at least dimensional data (dimensions of the reservoir, location, volume, etc.) as well as geological data, including rock types, petrophysical parameters such as porosity, permeability, saturation, etc. The geological description may include, or be derived from, various types of ground data acquired on the reservoir, such as:
seismic data,
well log data, and
core and plug data.

Geological maps and cross sections, identifying geological features such as faults and fractures as well as stratigraphy information.

In one or more embodiments, the geological description of the subsoil comprising the hydrocarbon reservoir may be a three-dimensional model elaborated from ground data, and populated with the above-mentioned petrophysical parameters. The geological description may also comprise data obtained from fluid flow simulations implemented in such a model.

In one or more embodiment, and optionally, the method may comprise, prior to obtain the meshed representation, a step for building the meshed representation representing the reservoir's flow entities and their relationships based on the geological description, the meshed representation serving as a model for the method of the present disclosure.

Such meshed representation may comprise nodes N and edges E connecting the nodes. Each flow entity may be described by a node called flow entity node and each link between the flow entities may be described by an edge called flow entity edge E.

Thus, for instance, the flow entity 110a may be described by the node N₁, the flow entity 110e may be described by the node N₃, etc. Likewise, the link between the flow entities 110a and 110c, i.e., Nodes N₁ and N₄, may be described by the flow entity edge E₁₄, and the link between the flow entities 110a and 110b, i.e., Nodes N₁ and N₂, may be described by the flow entity edge E₁₂.

Each flow entity node may represent a potential or existing flow entity within/around the hydrocarbon reservoir (or reservoir).

According to one or more example, each flow entity node may be assigned geographic coordinates (not represented) along at least two axes X and Y contained in a horizontal plane, and optionally along a third axis, orthogonal to X and Y, that specify the location of the flow entity corresponding to the flow entity node within/around the hydrocarbon reservoir.

Furthermore, the flow entity nodes may be described by at least one property called flow entity property, so that the flow entity nodes being ordered according to the at least one flow entity property, and such that each flow entity node has a respective rank according to the at least one flow entity property.

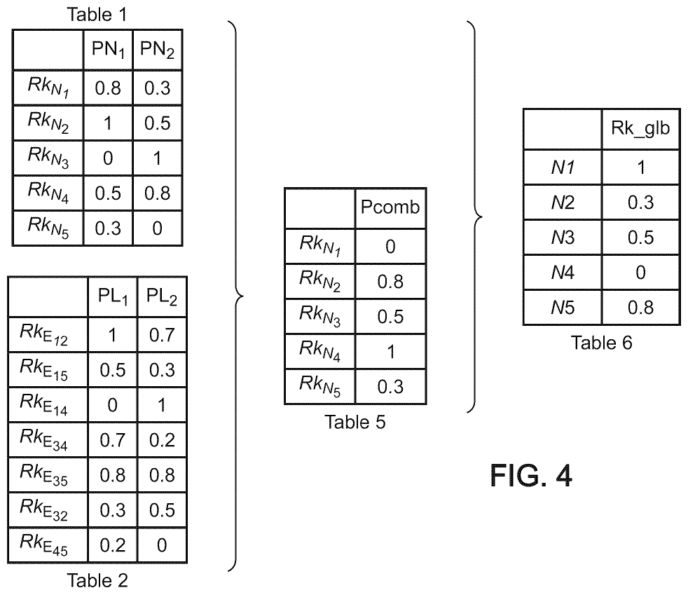

Table 1 of FIG. 4 illustrates such as ordering of the flow entity nodes according to the at least one flow entity property. According to one or more embodiments, the rank may be comprised between 0 and 1. Of course, other notation(s) of the ranks may be possible, such comprised between 0 and 10, etc.

Thus, in reference table 1 of FIG. 4, according to the flow entity property PN₁, the flow entity node N₁ may have the rank 0.8 among other flow entity nodes, and the flow entity node N₅ may have the rank 0.3 among other flow entity nodes.

Likewise, the flow entity edges may be described by at least one property called flow entity relationship property, so that the flow entity edges may be ordered according to the at least one flow entity relationship property, and such that each flow entity edge has a respective rank according to the at least one flow entity relationship property.

Table 2 of FIG. 4 illustrates such as ordering of the flow entity edges according to the at least one flow entity relationship property. For instance, according to the flow entity relationship property PL₁, the flow entity edge E₁₄ may have the rank 0 among other flow entity edges, and the flow entity edge E₃₂ may have the rank 0.3 among other flow entity edges.

Depending on the chosen convention, the highest rank may correspond to the highest value of the rank, such 1, and the lowest rank may correspond to the smallest value of the rank, such 0. Inversely, the highest rank may correspond to the smallest value of the rank, such 0, and the lowest rank may correspond to the highest value of the rank, such 1. Such interpretations may be considered for all the present disclosure.

In one or several embodiments, one or more ranks of the properties may be derived from the geological description of the subsoil comprising the hydrocarbon reservoir.

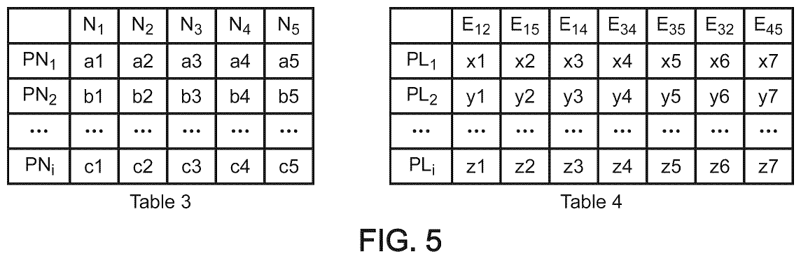

Table 1 and table 2 may respectively be derived from tables 3 and 4 of FIG. 5 according to one or more examples. Indeed, in one or more embodiments, one or more respective ranks according to the properties, such the at least one flow entity property and the at least one flow entity relationship property, may be derived from one or more respective values obtained by experimental measurements performed in the subsoil 120 of the area 100, such using seismic image(s) or by using conventional techniques suitable for measuring such respective value(s).

In one or several embodiments, one or more respective values of the properties may be derived from the geological description of the subsoil comprising the hydrocarbon reservoir, as presented previously.

More specifically, in one or several embodiments, each flow entity node may be described by a respective value of the at least one flow entity property, and each flow entity edge may be described by a respective value of the at least one flow entity relationship property, and the method may comprise:
for each flow entity node, determining the respective rank for the at least one flow entity property from a comparison between the respective value of the flow entity node for the at least one flow entity property with the respective values of the other flow entity nodes for the at least one flow entity property; and
for each flow entity edge, determining the respective rank for the at least one flow entity relationship property from a comparison between the respective value of the flow entity edge for the at least one flow entity relationship property with the respective values of the other flow entity edges for the at least one flow entity relationship property.

Thus, in reference to table 3 of FIG. 5, each flow entity node N may be defined by a respective value of the flow entity property PN₁. A respective value of a flow entity node according to a flow entity property may characterize the flow entity described by the corresponding node (or flow entity node). Thus, for instance, the flow entity nodes N₁ and N₄ may respectively have the value a1 and a4 according to the flow entity property PN₁. From the respective values a1 to a5, a respective rank (Rk) may be determined for each entity flow node according to the flow entity property PN₁.

Likewise, in reference to table 4 of FIG. 5, each flow entity edge E may be defined by a respective value of the flow entity relationship property PL₁. A respective value of a flow entity edge E according to a flow entity relationship property PL₁ may characterize a link described by the corresponding flow entity edge E. Thus, for instance, the flow entity edges E₁₂ and E₃₄ may respectively have the value x1 and x4 according to the flow entity relationship property PL₁. From the respective values x1 to x7, a respective rank may be determined for each flow entity edge according to the flow entity relationship property PL₁.

In one or several embodiments, the at least one flow entity property may be chosen among:
a Cumulated oil production;
a Gas in place around flow entity;
a Lorenz heterogeneity coefficient computed along a drain interval;
a Gas oil ratio;
a Bottom Hole Flowing Pressure; and
a Priority computed from any pre-existing method (such as Waterflood optimization or Proportional Integral Derivative or else).

In one or several embodiments, the at least one flow entity relationship property may be chosen among:
a Euclidian distance;
a Time of flight;
an Allocation factor;
a Time to breakthrough or Time to given water cut level;
an Interference profile; and
a Capacity or a Resistance resulting from a CRM modelling approach.

The allocation factor and Time to breakthrough and Time to given water cut level as a flow entity relationship property may be understood in the meaning of waterflood optimization.

The Time of fight as a flow entity relationship property may be understood in the meaning of the Fast marching Method or tracer simulation.

The method may further consist of determining 240 at any simulated time an order of the flow entity nodes according to at least one property called combined node-edge property (or combined node edge property).

The combined node-edge property may be derived from a flow entity property among the at least one flow entity property and a flow entity relationship property among the at least one flow entity relationship property, each rank (Rk) of a flow entity node according to the at least one combined node-edge property may be determined from:
the respective ranks according to a flow entity property among the at least one flow entity property of the flow entity nodes directly connected to the flow entity node; and
the respective ranks according to a flow entity relationship property among the at least one flow entity relationship property of the flow entity edges directly connected to the flow entity node.

By the flow entity nodes directly connected to the flow entity node, it may be understood that the flow entity nodes are directly connected by a respective edge (or at least one respective edge) to the flow entity node.

Thus, in reference to table 1 and table 2 of FIG. 4, by considering (only for example purpose) only one flow entity property PN₁ for the flow entity nodes and only one flow entity relationship property PL₁ for the flow entity edges, the respective rank of the flow entity node N₁ according to a combined node-edge property Pcomb may be determined (or calculated) based on the respective ranks of the flow entity nodes N₂, N₄, N₅ according to the flow entity property PN₁ and based on the respective ranks of the flow entity edges E₁₂, E₁₄, E₁₅ according to the flow entity relationship property PL₁, and which are directly connected to the flow entity node N₁.

Table 5 of FIG. 4 illustrates ranks (Rk) of the flow entity nodes according to the combined node-edge property Pcomb. Note that Table 5 is only for purpose of illustration, and does not result of calculation from tables 1 and 2.

In one or more embodiments, the respective ranks for the flow entity nodes according to the at least one combined node-edge property may be determined as follows:
for each flow entity node N for the at least one combined node edge property, determining a sum S for the flow entity node according to:

$${S}_{N}^{( P N ; P L )} = ( {\sum }_{all DistantNodes nodes}^{all Node to - DistantNode edges} {Rank}_{DistantNodes}^{DistantNode} ( PN ) \cdot {Rank}_{to - DistantNode edges}^{to - DistantNode edge} ( P L ) )$$

wherein

$${Rank}_{DistantNodes}^{DistantNode}$$

is a rank according to a flow entity property PN among the at least one flow entity property of a DistantNode, the DistantNode being directly connected to the flow entity node, and

$${Rank}_{to - DistantNodes edges}^{to - DistantNode edge}$$

is a rank according to an flow entity relationship property PL among the at least one flow entity relationship property of a flow entity edge, the flow entity edge being directly connected to the flow entity node; and
determining a respective rank for each flow entity node for the at least one combined node-edge property from a comparison between the respective sum calculated for the flow entity node with the sums calculated for the other flow entity nodes.

In the following of the previous example, in the case of the flow entity node N₁, and based on the tables 1 and 2, the sum

$${s}_{N 1}^{( P N 1 ; P L 1 )}$$

may be expressed as follows:

$${s}_{N 1}^{( P N 1 ; P L 1 )} = R {k}_{{N}_{2}} ( P {N}_{1} ) \cdot {Rk}_{{E}_{12}} ( P {L}_{1} ) + {Rk}_{{N}_{4}} ( P {N}_{1} ) \cdot {Rk}_{{E}_{14}} ( P {L}_{1} ) + R {k}_{{N}_{5}} ( P {N}_{1} ) \cdot {Rk}_{{E}_{15}} ( {PL}_{1} ) = ( 1 ) \cdot ( 1 ) + ( 0.5 ) \cdot ( 0 ) + ( 0.3 ) \cdot ( 0.5 ) = 1.5$$

By comparing the calculated sums of flow entity nodes N (or by ordering between them the calculated sums), a respective rank may be determined for each flow entity node according to the at least one combined node-edge property Pcomb, as illustrated at table 5 of FIG. 4.

The method may further consist of applying 260 at least one variation parameter to at least one among the at least one flow entity property and the at least one combined node-edge property.

In one or more embodiments, the at least one variation parameter may be applied to the ranks of the properties. Thus, for instance, the at least one variation parameter may be applied on the ranks of a flow entity property and/or the ranks of a combined node-edge property.

For instance, the variation parameter V₁ may be applied to the flow entity property PN₁, then the variation parameter may be applied to the ranks Rk_{N}_{₁} to Rk_{N}_{ₛ} (of the flow entity nodes N₁ to N₅).

In one or several embodiments, after applying one or several variation parameters, a normalization of the ranks may be performed, so that the ranks being comprised between a predetermined range, such for instance between 0 and 1.

According to one or more examples, the variation parameter of a property may be a directional parameter determining an impact of the evolution of a property according to a given direction on a rank of a flow entity node. More specifically, the directional parameter may be a coefficient of direction which may indicate whether or not a given property should be maximized or minimized in the subsequent steps of the method. The directional parameter may transcribe the relevance of a rank (or its respective value) of a flow entity node regarding the property. For instance, it may consider that a respective value or rank for a given property may be optimal or not when it is high or low, maximum or minimum, or in the average, etc., and for another given property, it may be different.

In one or several embodiments, the directional parameter may be applied on the ranks through a function, such a trigonometric function for instance. According to an example, the trigonometric function may be a cosine or sinus function. The function may depend on the directional parameter which may be set automatically, for instance based on a database, or defined by a user such reservoir engineers and/or reservoir geologists.

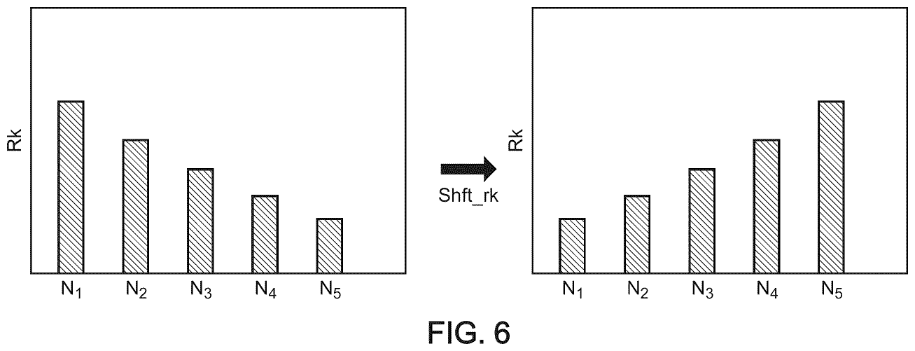

FIG. 6 illustrates an example of effect on the ranks when applying a directional parameter through a trigonometric function. The ranks of FIG. 6 are for illustration purpose of the directional parameter and are not calculated from the previous presented tables. Thus, such directional parameter allows to move the order of the ranks for a given property. In the case of FIG. 6, a sinus function is used with a directional parameter equal to 0.5, allowing to inverse (shft_rk) the order of the ranks (Rk) of the flow entity nodes for a given property.

The method may then consist of determining 280 the optimized control of the flow entities from at least an order of the flow entities determined by using an optimization of a cost function, the at least one variation parameter being an optimization variable, the optimization comprising iterations of:
determining a plurality of global ranks for the flow entity nodes, each global rank of a flow entity node being determined from the respective rank of the flow entity node for the at least one flow entity property and from the respective rank of the flow entity node for the at least one combined node-edge property;
determining an order of the flow entities based on the global ranks; and
evaluating the cost function based on the determined order of the flow entities.

Thus, in reference to FIG. 4, by considering (only for example purpose) only one flow entity property PN₁ and only one combined node-edge property Pcomb for the flow entities nodes, the global rank of the flow entity node N₁ (relative to the flow entity 110a) may be determined based on the rank of the flow entity node N₁ according to the flow entity property PN₁ and the rank of the flow entity node N₁ according to the combined node-edge property Pcomb.

Table 6 of FIG. 4 illustrates an order of global ranks (Rk_glb) obtained from table 5 and table 1, and which forms a determined order of flow entities. Note that Table 6 is for only purpose of illustration, and does not result of calculation from tables 1 and 5.

Once all the global ranks of the flow entity nodes are determined for an iteration, the determined order of the flow entities formed by the global ranks of the flow entity nodes (related to the flow entities) may be used to evaluate the cost function. The iterations may continue up to reach an optimization of the cost function, such as a minimization or maximization for instance, in order to determine an optimized control of the flow entities which may be based (or correspond to) on at least the order of the flow entities. An iteration may comprise at least one modification of the at least one variation parameter as optimization variable.

Thus, advantageously, an optimized control of the flow entities may be simply determined by transforming the input data into ranks, corresponding to an order of the flow entities. In the context of the present disclosure, the optimized control of the flow entities may also correspond (or based on) to at least a determined order of the flow entities (minimizing a cost function), which is determined by varying at least one variation parameter such the directional parameter and/or the weight. According to an example, depending on the type of flow entity(ies), the order may be the order of well openings, the order of well drilling, the order for adding flow assistance equipment (pumps, gas lift mandrels) to flow entities, etc. A benefit of the approach relates to the reduced number of parameters involved in the determination of ranks compared to alternate methods while maintaining an ability to investigate a wide and diverse range of rank combination. Another benefit lies in the ability to establish a relation between performing designs and input properties (explainability).

The optimized control of flow entities of a hydrocarbon reservoir may be for a hydrocarbon exploitation which is installed, or in operation, or will be installed or will be modified.

In one or several embodiments, the cost function may be chosen among a cumulated production or injection, a Discounted Net present Value, or a Return on Investment.

According to one or more examples, determining the plurality of global ranks may comprise:
for each flow entity node, calculating a respective distance for the flow entity node from the respective rank of the flow entity node for the at least one flow entity property and from the respective rank of the flow entity node for the at least one combined node-edge property; and
determining a global rank for each flow entity node from a comparison between the respective distance calculated for the flow entity node with the distances calculated for the other flow entity nodes.

According to one or more examples, the respective distance D_{N} for a flow entity node N may be calculated by a sum of the ranks of the flow entity node.

For instance, the distance D_{N2} for the flow entity node N₂ may be calculated according to:

$${D}_{N 2} = R {k}_{N 2} ( P {N}_{1} ) + R {k}_{N 2} ( Pcomb ) = 1 + 0.8 = 1.8$$

where Rk_{N2}(PN₁) is the rank of the flow entity node N₂ according to the flow entity property PN₁, i.e., 1, and Rk_{N2} (Pcomb) is the rank of the flow entity node N₂ according to the combined node-edge property Pcomb, i.e., 0.8.

The calculated distances D_{N} of the flow entity nodes may be compared between them in the purpose to determine an order of the flow entity nodes (or the flow entities), i.e., using ranks. The highest rank may correspond to the smallest calculated distance or the longest calculated distance, depending on the chosen convention.

The previous example(s) are presented, for the purpose of simplification, with only flow entity property and only one flow entity relationship property. However, the flow entity nodes and the flow entity edges may be described by a plurality of properties. The previous embodiments and examples may be applied to the following.

Thus, in one or several embodiments, the flow entity nodes may be described by a plurality of flow entity properties and/or the flow entity edges may be described by a plurality of flow entity relationship properties, and the ranks may be determined according to a plurality of combined node-edge properties for the flow entity nodes such that each flow entity node has a respective rank for each combined node-edge property of the plurality of combined node-edge properties.

In reference to table 1 and table 2 of FIG. 4, according to an example, the flow entity nodes may be described by two flow entity properties PN₁ and PN₂, and the flow entity edges may be described by two flow entity relationship properties PL₁ and PL₂. In such case, and based on previously, each flow entity node N may be described by four combined node-edge properties, so that all property combinations may be covered. With the properties PL₁, PL₂, PN₁, and PN₂, the combination may be (PN₁;PL₁), (PN₁;PL₂), (PN₂;PL₁), and (PN₂;PL₂), each combination corresponding to a combined node edge property Pcomb. The four combined node edge properties Pcomb₁, Pcomb₂, Pcomb₃, Pcomb₄ may respectively have a rank calculated from the ranks of tables 1 and 2 of FIG. 4. As presented previously, table 1 and table 2 may respectively be derived from tables 3 and 4 of FIG. 5 according to one or more examples.

Thus, based on the above and according to the previous equation, a sum may be determined for each property combination Pcomb and for each flow entity node N. The calculated sums of the flow entity nodes for a property combination, i.e., a combined node edge property, may be compared between them in order to determine the ranks of the flow entity node according to this combined node edge property Pcomb. According to an example, in the case of the flow entity node N₁, the calculated sums

$${S}_{N 1}^{( P N 1 ; P L 1 )}$$

$$and$$

$${S}_{N 1}^{( P N 1 ; P L 2 )}$$

for the combination (PN₁;PL₁) and (PN₁;PL₂), allowing to determine the combined node edge properties Pcomb₁ and Pcomb₂, may be as follows:

$${S}_{N 1}^{( P N 1 ; P L 1 )} = R {k}_{{N}_{2}} ( P {N}_{1} ) \cdot {Rk}_{{E}_{12}} ( P {L}_{1} ) + {Rk}_{{N}_{4}} ( P {N}_{1} ) \cdot {Rk}_{{E}_{14}} ( P {L}_{1} ) + R {k}_{{N}_{5}} ( {PN}_{1} ) \cdot {Rk}_{{E}_{15}} ( P {L}_{1} )$$

$${S}_{N 1}^{( P N 1 ; P L 2 )} = R {k}_{{N}_{2}} ( P {N}_{1} ) \cdot {Rk}_{{E}_{12}} ( P {L}_{2} ) + R {k}_{{N}_{4}} ( P {N}_{1} ) \cdot {Rk}_{{E}_{14}} ( P {L}_{2} ) + R {k}_{{N}_{5}} ( P {N}_{1} ) \cdot {Rk}_{{E}_{15}} ( P {L}_{2} )$$

The combined node edge properties of a flow entity node may be taken into account for determining the calculated distance of the flow entity node. More specifically, the calculated distance for the flow entity node N may be calculated by the sum of the ranks of the flow entity node N, i.e., all the ranks of all the combined node-edge properties and all the ranks of the flow entity properties (for this flow entity node N). The calculated distance may be expressed as follows:

$${D}_{N} = {\sum }_{i = 1}^{{n}_{P N}} R {k}_{N} ( P {N}_{i} ) + {\sum }_{j = 1}^{{n}_{P c o m b}} R {k}_{N} ( {Pcomb}_{j} )$$

wherein n_{PN} is the number of flow entity properties, n_{Pcomb} is the number of combined node-edge properties, Rk_{N}(PNᵢ) is the rank of the flow entity node N according to a flow entity property PNᵢ, and Rk_{N}(Pcombⱼ) is the rank of the flow entity node N according to a combined node-edge property Pcombⱼ.

According to an example, in the case of the flow entity node N₁, and taking into account the flow node properties PN₁ and PN₂ as well as the combined node edge properties Pcomb₁, Pcomb₂, Pcomb₃, Pcomb₄, the distance for the flow entity node N₁, may be calculated according to:

$${D}_{N 1} = R {k}_{N 1} ( P {N}_{1} ) + R {k}_{N 1} ( P {N}_{2} ) + {Rk}_{N 1} ( P c o m {b}_{1} ) + R {k}_{N 1} ( P c o m {b}_{2} ) + R {k}_{N 1} ( P c o m {b}_{3} ) + {Rk}_{N 1} ( {Pcomb}_{4} )$$

where Rk_{N1}(PN₁) is the rank of the flow entity node N₁ according to the flow entity property PN₁, Rk_{N1}(PN₂) is the rank of the flow entity node N₁ according to the flow entity property PN₂, Rk_{N1} (Pcomb₁) is the rank of the flow entity node N₁ according to the combined node-edge property Pcomb₁, Rk_{N1} (Pcomb₂) is the rank of the flow entity node N₁ according to the combined node-edge property Pcomb₂, Rk_{N1} (Pcomb₃) is the rank of the flow entity node N₁ according to the combined node-edge property Pcomb₃, and Rk_{N1} (Pcomb₄) is the rank of the flow entity node N₁ according to the combined node-edge property Pcomb₄.

In the context of the present disclosure, it may be interesting to weigh the properties when a plurality of properties is used as presented above. Thus, according to one or more embodiments, the variation parameter of property may be a weight, so that the variation parameter may be chosen from at least:
the directional parameter determining an impact of the evolution of a property according to a given direction on a rank; and
a weight.

The weight may correspond to the importance given to a property, such as the flow entity property or the combined node edge property. The weight may be set automatically, for instance based on a database (or predetermined database), or defined by a user such reservoir engineers and/or reservoir geologists.

More specifically, the properties may be weighted among each other by a plurality of weights, and wherein the respective distance of each flow entity node may be further calculated from the plurality of weights.

In one or several embodiments, the weights may be comprised between 0 and 1, and the sum of the weights may be equal at 1.

The calculated distance D_{N} for a flow entity node N which takes into account the weights of the properties may be calculated as follows:

$${D}_{N} = {\sum }_{i = 1}^{{n}_{P N}} {( R {k}_{N} ( P {N}_{i} ) - {w}_{{PN}_{i}} )}^{2} + {\sum }_{j = 1}^{{n}_{P c o m b}} {( R {k}_{N} ( P c o m {b}_{j} ) - {w}_{P c o m {b}_{j}} )}^{2}$$

wherein n_{PN} is the number of flow entity properties, n_{Pcomb} is the number of combined node-edge properties, Rk_{N}(PNᵢ) is the rank of the flow entity node N according to a flow entity property PNᵢ, w_{PN}_{ᵢ} the weight of the flow entity property PNᵢ, Rk_{N}(Pcombⱼ) is the rank of the flow entity node N according to a combined node-edge property Pcombⱼ, and w_{Pcomb}_{ⱼ} the weight of the combined node-edge property Pcombⱼ.

Thus, in the purpose of the previous example for the flow entity node N₁, the calculated distance for the node N₁ with a given plurality of weights (0.2, 0.25, 0.1, 0.15, 0.2, 0.1), with the sum of weights equal to 1, may be expressed as the following:

$${D}_{N 1} = {( R {k}_{N 1} ( P {N}_{1} ) - 0.2 )}^{2} + {( R {k}_{N 1} ( P {N}_{2} ) - 0.25 )}^{2} + {( R {k}_{N 1} ( P c o m {b}_{1} ) - 0.1 )}^{2} + {( {Rk}_{N 1} ( P c o m {b}_{2} ) - 0.15 )}^{2} + {( R {k}_{N 1} ( P c o m {b}_{3} ) - 0.2 )}^{2} + {( R {k}_{N 1} ( P c o m {b}_{4} ) - 0.1 )}^{2}$$

According to one or more embodiments, each calculated distance may correspond to a distance in a hypercube.

In one or several embodiments, the optimization may take into account at least one order constraint chosen among:
imposing ordering constraint between specific flow entities; and
imposing ordering constraint between specific groups of flow entities.

According to one or more examples, imposing ordering constraint between specific flow entities may be that a first flow entity must appear before a second flow entity, irrespective of ordering of other flow entities.

According to one or more examples, imposing ordering constraint between specific groups of flow entities may be that a plurality of flow entities belonging to a first group of flow entities among other groups of flow entities must appear before any flow entity belonging to a second group can appear, irrespective of ordering of other flow entities (or group of flow entities).

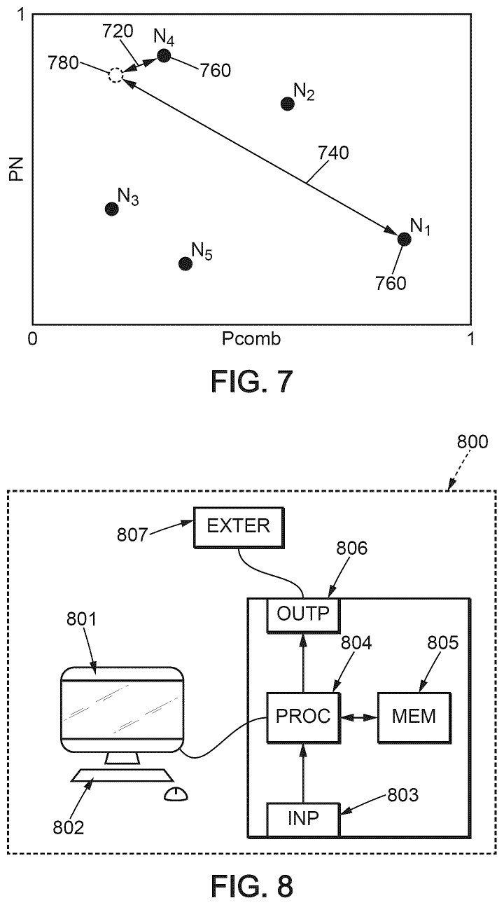

FIG. 7 illustrates an example of a hypercube in two dimensions.

In FIG. 7, in the view of illustration purpose, it considered only one flow entity property PN for the flow entity nodes associated to a given weight and only one combined node-edge property Pcomb for the flow entity nodes associated to a given weight.

Each calculated distance, such 720 and 740, of a flow entity node in the hypercube may be defined by a first point 760 having as coordinates the ranks of the properties, i.e., the flow entity property(ies) and the combined node edge priority(ies), and a second point 780 having as coordinates the weights of the properties. The second point 780 may be common to all the calculated distances, and may correspond to the desired balance of the properties in the hypercube, so that the shortest calculated distance, i.e., having its first point closest to the second point of a flow entity node, may correspond to the highest (or lowest rank) rank and the longest calculated distance, i.e., having its first point farthest to the second point, of a flow entity node may correspond to the lowest (or highest) rank. Thus, in reference to FIG. 7, the flow entity node N₄ may present the shortest distance 720, and the flow entity node N₁ may present the longest distance 760.

By ordering the calculated distances, global ranks may be determined in order to determine an order of the flow entities, as presented at table 6 of FIG. 4.

In the context of the domain of the present disclosure, it may be also interesting to determine one or more priorities of the flow entities.

Thus, in one or several embodiments, the optimized control of the flow entities may further be determined from at least a list of flow entity priorities using the optimization of the cost function, the flow entity priorities may be obtained by transforming a determined order of the flow entities factoring at least one application constraint at entity level for each entity.

The priorities may be understood as allocation factors, and may correspond to the fraction of a flow target or rate applicable to a group of flow entities applicable to a given flow entity part of the group.

During the optimization of the cost function, from a determined order of a set of flow entities, a list of flow entity priorities may be determined and used to evaluate the cost function in the purpose to further determine the optimized control of the flow entities. The cost function may be the same as those used for evaluating a determined order of flow entities as previously presented. According to one or more examples, the cost function used for determining the priorities of the flow entities may be different (or not) from the cost function used for determining the order of flow entities.

According to one or more embodiments, properties to be considered, weights and directional parameters might be specific or not to the nature of most constraining constraint applicable to the group of flow entities within which order or priorities are to be determined or the order by which such constraint apply; the order being determined recursively by removing more constraining constraint and reapplying constraints until no constraint is applicable.

According to one or more embodiments, the determined order of the flow entities may be transformed into the list of flow entity priorities based on a beta law cumulative distribution function and based on the at least one application constraint at flow entity level of each flow entity, the beta law cumulative distribution function being dependent on parameters alpha and beta as variation parameters.

Thus, advantageously, an optimized control of the flow entities (or of the repartition of flow entities) based on a list of flow entity priorities may be simply determined by transforming a determined order of flow entities in a series of flow priorities. In the context of the present disclosure, the optimized control of the flow entities may also correspond to (or based on) at least a list of flow entity priorities, also called allocation factors, which is determined by varying at least one variation parameter such the directional parameter and/or the weight and/or alpha and/or beta. According to an example, depending on the type of flow entity, well priorities can control the way flow for a considered flow quantity, constrained for a group of flow entities, is distributed across the entities constituting such group. Another benefit is that the flow priorities depend solely on the order of flow entities making the problem more suited to optimization process and more explainable.

The optimized control of flow entities of a hydrocarbon reservoir may be for a hydrocarbon exploitation which is installed, or in operation, or will be installed or will be modified.

According to one or several embodiments, an optimized control of the flow entities may be determined from an order of the flow entities and a list of flow entity priorities which are determined using the optimization of the cost function with at least a first variation parameter and at least a second variation parameter as optimization variables.

The at least first variation parameter may be chosen among a directional parameter and a weight, and the at least second variation parameter may be chosen among an alpha parameter and a beta parameter. Thus, In the context of the present disclosure, the optimized control of the flow entities may also correspond to (or based on) at least a list of flow entity priorities and to at least a determined order of the flow entities (minimizing a cost function), which may be determined by varying at least one variation parameter such the directional parameter and/or the weight and/or alpha and/or beta.

More specifically, during the optimization of the cost function, the variation parameters such the weights, the directional parameter, alpha, and beta, may be modified in order to determine an optimized control of the flow entities from an order of the flow entities and a list of flow entity priorities which are determined using the optimization of the cost function and based on these variation parameters.

Thus, in the context of the present disclosure, an optimized control of the flow entities may correspond to (or based on) at least a determined order of the flow entities and/or to at least a list of flow entity priorities. According to an example, the optimized control of the flow entities which is determined may comprise an order of well openings or an order of well drilling, and may also comprise well priorities for controlling the way flow for a considered flow quantity, constrained for a group of wells.

In one or several embodiments, the at least one application constraint may be chosen among:
a rate constraint pertaining to a given fluid stream; and
a pressure or temperature constraint pertaining to a given point in a flow system.

According to one or several examples, a rate constraint pertaining to a given fluid stream may be an oil rate below a predetermined value, a gas lift rate below a predetermined rate.

According to one or more examples, a pressure or temperature constraint pertaining to a given point in a flow system may be bottom hole pressure higher or equal to a predetermined value.

In one or several embodiments, the list of flow entity priorities may be transformed as follows:
computing unconstrained cumulated priorities using the beta law cumulative distribution function and the global ranks of the determined order of the flow entities;
computing unconstrained individual priorities for each flow entity by differentiating two successive unconstrained cumulated priorities;
computing a flow target for each flow entity and each application constraint of the at least one application constraint by multiplying the application constraint at the group level by the unconstrained individual priorities computed;
computing a maximum individual constrained priority per flow entity as a proportion between the flow target of the flow entity and the flow target of the application constraint whenever the application constraint is exceeded; and
determining the list of flow entity priorities by summing the individual constrained priorities and redistributing recursively the difference between individual constrained priorities and unconstrained individual priorities over individual unconstrained flow entities according to their individual unconstrained priorities until all flow entities are constrained or a redistribution is achieved without an entity reaching a constraint.

By unconstrainted/constrained, it may be understood unconstrained/constrained regarding the application constraint.

In one or several embodiments, the optimization may take into account at least one priority constraint chosen among:
priority value of flow entity must be lower or higher than a predetermined value; and
priority value of a first flow entity must be lower or higher than priority value of a second flow entity.

FIG. 8 is a possible embodiment for a computing device that enables the present disclosure.

In this embodiment, the computing device 800 may comprise a circuit 804 and a memory 805 coupled to the circuit 804, and configured to store program instructions loadable into the circuit and adapted to cause circuit 804 to carry out the steps of the present disclosure when the program instructions are run by the circuit 804.

Memory 805 may also store data and useful information for carrying out the steps of the present disclosure as described above. In one or several examples, the memory may comprise a meshed representation of the flow entities, and/or a geological description of the hydrocarbon reservoir for building the meshed representation, and/or one or more variations parameters, and/or one or more respective values, and/or at least one application constraint, and/or at least one priority constraint, and/or at least one order constraint.

The memory may include volatile memory elements (e.g., random access memory (RAM)) and/or non-volatile memory elements (e.g., read-only memory (ROM), flash memory, hard drive, etc.). The memory may store various program modules and data, including an operating system, application programs, and the method's instructions.

The circuit 804 may be for instance:
a processor or a processing unit adapted to interpret instructions in a computer language, the processor or the processing unit may comprise, may be associated with or be attached to a memory comprising the instructions, or
the association of a processor/processing unit and a memory, the processor or the processing unit adapted to interpret instructions in a computer language, the memory comprising the instructions, or
an electronic card wherein the steps of the disclosure are described within silicon, or
a programmable electronic chip such as a FPGA chip (for «Field-Programmable Gate Array»), or
graphics processing units (GPUs), or
application-specific integrated circuits (ASICs).

The processor may be a single-core or multi-core processor, with each core capable of executing instructions independently. In a multi-core processor, the cores may work in parallel to perform the method's steps more efficiently.

The computing device 800 may be a computer comprising the circuit and the memory.

This computing device 800 may comprise an input interface 803 for the reception of at least one input parameter (such a geological description of the hydrocarbon reservoir for building the meshed representation, and/or a meshed representation of the flow entities, and/or one or more variations parameters, and/or one or more respective values, and/or at least one application constraint, and/or at least one priority constraint, and/or at least one order constraint, etc.) used for the above method according to the disclosure and an output interface 806 for providing at least one output parameter such those according to the present disclosure, such output parameter(s) may be provided to an external device 807 (or external computing device). For instance, the output parameters may be an order of flow entities and/or priorities of flow entities and/or an optimized control of the flow entities based on these order and priorities.

The computing device may also include a communication interface (not represented) for communicating with other devices or systems, such as a network interface card (NIC) for connecting to a local area network (LAN), wide area network (WAN), or the Internet. For instance, the communication interface may be used to receive at the input parameter(s) and/or sent output parameter(s).

To ease the interaction with the computing device such a computer, a screen 801 and a keyboard 802 may be provided and connected to the circuit 804.

In some embodiments, the computing device may be a server, a desktop computer, a laptop computer, a tablet, a smartphone, or any other suitable computing device capable of executing the method's instructions.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the disclosure.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method for determining an optimized control of flow entities of a hydrocarbon reservoir, the method comprising:
a/ obtaining a meshed representation of flow entities, said representation comprising nodes and edges connecting the nodes, each flow entity being described by a node called flow entity node and each link between the flow entities being described by an edge called flow entity edge, the flow entity nodes being described by at least one property called flow entity property and the flow entity edges being described by at least one property called flow entity relationship property,
the flow entity nodes being ordered according to said at least one flow entity property such that each flow entity node has a respective rank according to said at least one flow entity property,
and the flow entity edges being ordered according to said at least one flow entity relationship property such that each flow entity edge has a respective rank according to said at least one flow entity relationship property;
b/ determining at any simulated time an order of the flow entity nodes according to at least one property called combined node-edge property, said combined node-edge property being derived from a flow entity property among said at least one flow entity property and a flow entity relationship property among said at least one flow entity relationship property, each rank of a flow entity node according to said at least one combined node-edge property being determined from:
the respective ranks according to a flow entity property among said at least one flow entity property of the flow entity nodes directly connected to the flow entity node; and
the respective ranks according to a flow entity relationship property among said at least one flow entity relationship property of the flow entity edges directly connected to the flow entity node;
c/ applying at least one variation parameter to at least one among the at least one flow entity property and the at least one combined node-edge property; and
d/ determining the optimized control of the flow entities from at least an order of the flow entities determined by using an optimization of a cost function, the at least one variation parameter being an optimization variable, said optimization comprising iterations of:
d1/ determining a plurality of global ranks for the flow entity nodes, each global rank of a flow entity node being determined from the respective rank of the flow entity node for said at least one flow entity property and from the respective rank of the flow entity node for said at least one combined node-edge property;
d2/ determining an order of the flow entities based on said global ranks; and
d3/ evaluating the cost function based on the determined order of the flow entities.

2. The method according to claim 1, wherein the at least one variation parameter of a property is chosen among at least:
a directional parameter determining an impact of the evolution of a property according to a given direction on a rank; and
a weight.

3. The method according to claim 1, wherein the flow entity nodes are described by a plurality of flow entity properties and/or the flow entity edges are described by a plurality of flow entity relationship properties, and in b/ the ranks are determined according to a plurality of combined node-edge properties for the flow entity nodes such that each flow entity node has a respective rank for each combined node-edge property of the plurality of combined node-edge properties.

4. The method according to claim 1, wherein determining the plurality of global ranks comprises:
for each flow entity node, calculating a respective distance for the flow entity node from the respective rank of the flow entity node for said at least one flow entity property and from the respective rank of the flow entity node for said at least one combined node-edge property; and
determining a global rank for each flow entity node from a comparison between the respective distance calculated for the flow entity node with the distances calculated for the other flow entity nodes.

5. The method according to claim 4, wherein the variation parameter is a weight such that the properties are weighted among each other by a plurality of weights, and wherein the respective distance of each flow entity node is further calculated from the plurality of weights.

6. The method according to claim 1, wherein each flow entity node is described by a respective value of said at least one flow entity property, and each flow entity edge is described by a respective value of said at least one flow entity relationship property, and the method comprises in a/:
for each flow entity node, determining the respective rank for said at least one flow entity property from a comparison between the respective value of the flow entity node for said at least one flow entity property with the respective values of the other flow entity nodes for said at least one flow entity property; and
for each flow entity edge, determining the respective rank for said at least one flow entity relationship property from a comparison between the respective value of the flow entity edge for said at least one flow entity relationship property with the respective values of the other flow entity edges for said at least one flow entity relationship property.

7. The method according to claim 1, wherein in b/, the respective ranks for the flow entity nodes according to said at least one combined node-edge property are determined as follows:
for each flow entity node N for said at least one combined node-edge property, determining a sum S for the flow entity node according to:
$${S}_{N}^{( P N ; P L )} = ( {\sum }_{all DistantNodes nodes}^{all Node to - DistantNode edges} {Rank}_{DistantNodes}^{DistantNode} ( PN ) \cdot {Rank}_{to - DistantNode edges}^{to - DistantNode edge} ( P L ) )$$
wherein
$${Rank}_{DistantNodes}^{DistantNode}$$
is a rank according to a flow entity property PN among said at least one flow entity property of a DistantNode, said DistantNode being directly connected to the flow entity node, and
$${Rank}_{to - DistantNodes edges}^{to - DistantNode edge}$$
is a rank according to an flow entity relationship property PL among said at least one flow entity relationship property of an flow entity edge, said flow entity edge being directly connected to the flow entity node; and
determining a respective rank for each flow entity node for said at least one combined node-edge property from a comparison between the respective sum calculated for the flow entity node with the sums calculated for the other flow entity nodes.

8. The method according to claim 1, wherein said at least one flow entity property is chosen among:
a Cumulated oil production;
a Gas in place around flow entity;
a Lorenz heterogeneity coefficient computed along a drain interval;
a Gas oil ratio;
a Bottom Hole Flowing Pressure; and
a Priority computed from any pre-existing method.

9. The method according to claim 1, wherein said at least one flow entity relationship property is chosen among:
a Euclidian distance;
a Time of flight;
an Allocation factor in the meaning of Waterflood optimization;
a Time to breakthrough or Time to given water cut level;
an Interference profile; and
a Capacity or a Resistance resulting from a CRM modelling approach.

10. The method according to claim 1, wherein the optimization takes into account at least one order constraint chosen among:
imposing an ordering constraint between specific flow entities; and
imposing an ordering constraint between specific groups of flow entities.

11. The method according to claim 1, wherein the optimized control of the flow entities is further determined from at least a list of flow entity priorities determined by using the optimization of the cost function, the flow entity priorities being obtained by transforming a determined order of the flow entities factoring at least one application constraint at entity level for each entity.

12. The method according to claim 11, wherein the determined order of the flow entities is transformed into the list of flow entity priorities based on a beta law cumulative distribution function and based on the at least one application constraint at flow entity level of each flow entity, the beta law cumulative distribution function being dependent on parameters alpha and beta as variation parameters.

13. The method according to claim 11, wherein the optimization takes into account at least one priority constraint chosen among:
a priority value of a flow entity must be lower or higher than a predetermined value; and
a priority value of a first flow entity must be lower or higher than priority value of a second flow entity.

14. The method according to claim 11, wherein at least one application constraint is chosen among:
a rate constraint pertaining to a given fluid stream; and
a pressure or temperature constraint pertaining to a given point in a flow system.

15. The method according to claim 11, wherein the optimized control of the flow entities is determined from an order of the flow entities and a list of flow entity priorities which are determined using the optimization of the cost function with at least a first variation parameter and at least a second variation parameter as optimization variables, the at least first variation parameter is chosen among a directional parameter and a weight, and the at least second variation parameter is chosen among an alpha parameter and a beta parameter.

16. The method according to claim 11, wherein the list of flow entity priorities is determined by transformation as follows:
computing unconstrained cumulated priorities using the beta law cumulative distribution function and the global ranks of the determined order of the flow entities;
computing unconstrained individual priorities for each flow entity by differentiating two successive unconstrained cumulated priorities;
computing a flow target for each flow entity and each application constraint of the at least one application constraint by multiplying the application constraint at the group level by the unconstrained individual priorities computed;
computing a maximum individual constrained priority per flow entity as a proportion between the flow target of the flow entity and the flow target of the application constraint whenever the application constraint is exceeded; and
determining the list of flow entity priorities by summing the individual constrained priorities and redistributing recursively the difference between individual constrained priorities and unconstrained individual priorities over individual unconstrained flow entities according to their individual unconstrained priorities until all flow entities are constrained or a redistribution is achieved without an entity reaching a constraint.

17. The method according to claim 1, wherein the cost function is chosen among a Cumulated production or injection, a Discounted Net present Value, or a Return on Investment.

18. The method according to claim 1, wherein a flow entity is at least one flow entity chosen among:
a producer well or a group of producer wells;
an injector well or a group of injector wells;
a drain production interval or a group of drain production intervals; and
a drain injection interval or a group of drain injection intervals.

19. A computer program product comprising instructions which, when the program is executed by a computer, cause the computer to carry out the method of claim 1.

20. A computing device for determining an optimized control of flow entities of a hydrocarbon reservoir, the computing device comprising a memory and comprising:
a/ a circuit for obtaining and for storing in the memory a meshed representation of flow entities, said representation comprising nodes and edges connecting the nodes, each flow entity being described by a node called flow entity node and each link between the flow entities being described by an edge called flow entity edge, the flow entity nodes being described by at least one property called flow entity property and the flow entity edges being described by at least one property called flow entity relationship property,
the flow entity nodes being ordered according to said at least one flow entity property wherein each flow entity node has a respective rank according to said at least one flow entity property,
and the flow entity edges being ordered according to said at least one flow entity relationship property wherein each flow entity edge has a respective rank according to said at least one flow entity relationship property;
b/ a circuit for determining at any simulated time an order of the flow entity nodes according to at least one property called combined node-edge property, said combined node-edge property being derived from a flow entity property among said at least one flow entity property and a flow entity relationship property among said at least one flow entity relationship property, each rank of a flow entity node according to said at least one combined node-edge property being determined from:
the respective ranks according to a flow entity property among said at least one flow entity property of the flow entity nodes directly connected to the flow entity node; and
the respective ranks according to a flow entity relationship property among said at least one flow entity relationship property of the flow entity edges directly connected to the flow entity node;
c/ a circuit for applying at least one variation parameter to at least one among the at least one flow entity property and the at least one combined node-edge property; and
d/ a circuit for determining the optimized control of the flow entities from at least an order of the flow entities determined by using an optimization of a cost function, the at least one variation parameter being an optimization variable, said optimization comprising iterations of:
d1/ determining a plurality of global ranks for the flow entity nodes, each global rank of a flow entity node being determined from the respective rank of the flow entity node for said at least one flow entity property and from the respective rank of the flow entity node for said at least one combined node-edge property;
d2/ determining an order of the flow entities based on said global ranks; and
d3/ evaluating the cost function based on the determined order of the flow entities.
